(19) United States
(12) Patent Application Publication
(10) Pub. No.: US 2023/0222491 A1
(43) Pub. Date: Jul. 13, 2023

(54) SYSTEMS AND METHODS FOR TRANSFER OF NON-FUNGIBLE ASSETS ACROSS MULTIPLE BLOCKCHAIN SYSTEMS

(71) Applicant: Verizon Patent and Licensing Inc., Basking Ridge, NJ (US)

(72) Inventors: Dante J. Pacella, Charles Town, WV (US); Ashish Sardesai, Ashburn, VA (US)

(73) Assignee: Verizon Patent and Licensing Inc., Basking Ridge, NJ (US)

(21) Appl. No.: 17/574,983

(22) Filed: Jan. 13, 2022

(51) Int. Cl. G06Q 20/36

(52) U.S. Cl. CPC G06Q 20/3678; G06Q 2220/00

(57) ABSTRACT

A system described herein may provide a technique for bridging an asset, such as a non-fungible asset (e.g., a Non-Fungible Token (“NFT”)) from one blockchain to another, while retaining the uniqueness and/or scarcity of the asset. The system may receive provenance information associated with the asset that is associated with a first blockchain, associate the particular asset with a particular identifier, and receive an instruction to bridge the asset to a second blockchain (e.g., from an owner of the asset). Based on receiving the instruction to bridge the asset to the second blockchain, the system may lock the asset on the first blockchain, and mint the asset on the second blockchain, wherein the minted asset includes the particular identifier. The identifier may be linked to off-chain data that associates the minted asset to the original asset, thus maintaining the chain of custody of the asset across the two blockchains.

### BACKGROUND

Blockchains provide for the decentralized and secure storage of data. Blockchains may further provide for the immutability of recorded data, as data may not be altered once recorded to a blockchain. The immutability of blockchains may thus provide for a secure record of provenance, chain of custody, etc. with data, assets, or the like. One such type of asset may include a non-fungible asset (e.g., a non-fungible token (“NFT”)), which may include unique attributes that are not shared by other assets (e.g., other NFTs). Bridges between different blockchains may allow for the provision of assets on one blockchain by locking assets (e.g., fungible assets) on another blockchain.

### BRIEF DESCRIPTION OF THE DRAWINGS

FIG. 1 illustrates an example overview of one or more embodiments described herein;

FIG. 2 illustrates an example registration of a bridging destination for one or more blockchain assets, in accordance with one or more embodiments described herein;

FIGS. 3A and 3B illustrate example off-chain data associated with a blockchain asset, in accordance with one or more embodiments described herein;

FIG. 4 illustrates an example of receiving an instruction to bridge an asset from one blockchain to another, in accordance with one or more embodiments described herein;

FIG. 5 illustrates an example of bridging an asset from one blockchain to another, in accordance with one or more embodiments described herein;

FIG. 6 illustrates an example of a marketplace presenting a bridged asset for trade, in accordance with one or more embodiments described herein;

FIG. 7 illustrates an example process for bridging an asset from one blockchain to another, in accordance with some embodiments;

FIG. 8 illustrates an example environment in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for the cross-chain transfer of assets, such as assets with unique characteristics or attributes (e.g., non-fungible assets such as NFTs), from one blockchain to another. In accordance with embodiments described herein, a non-fungible asset such as an NFT that is transferred from a first blockchain to a second blockchain may retain provenance attributes of the original non-fungible asset, such as time of creation of the original non-fungible asset, a unique identifier of the original non-fungible asset, a link or other indicator of data or information associated with the non-fungible asset (e.g., an image, a video, audio data, text, etc.), or the like. In this manner, the transferred non-fungible asset may retain the provenance, security, immutability, etc. provided by the first blockchain even when transferred, bridged, etc. to the second blockchain. As such, the validity, provenance, chain of custody, etc. of the transferred non-fungible asset may be maintained across multiple blockchains, and the non-fungible asset may retain its non-fungible, unique character.

Embodiments described herein are distinct from bridges that do not provide for such cross-chain transfer of unique characteristics of non-fungible assets (e.g., provenance information, unique identifier, etc.). For example, some bridges allow for the transfer of fungible assets, such as tokens, by locking a token on a first blockchain and creating, or “minting,” a “wrapped” version of the token on a second blockchain. In such situations, the “wrapped” token on the second blockchain may represent the existence of the token on the first blockchain, but may not retain particular attributes of the first token such as time of creation, unique identifier, etc. Such bridges may therefore be unsuitable for the transfer of non-fungible assets such as NFTs, which each are associated with unique characteristics.

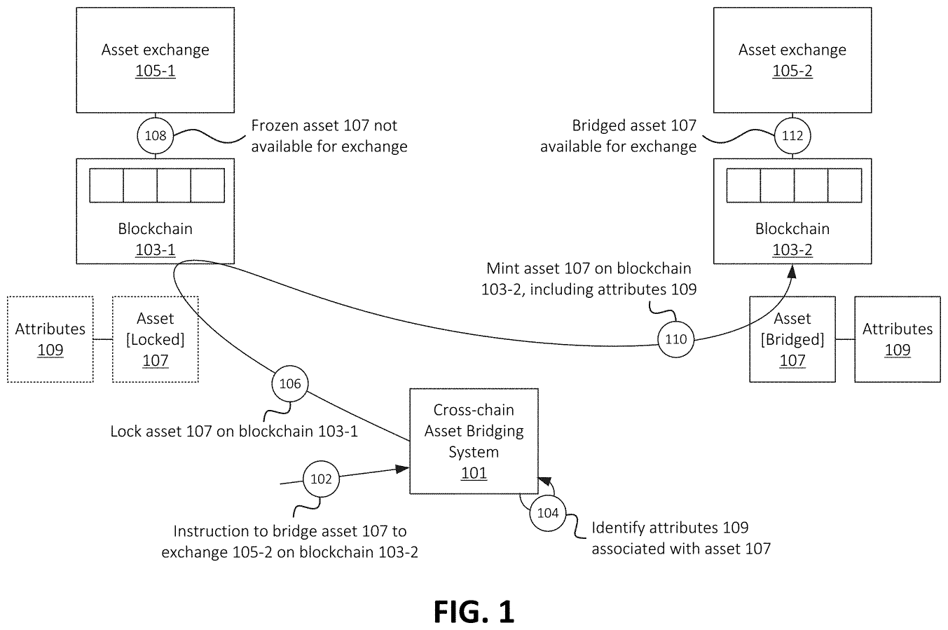

FIG. 1 illustrates a high-level overview of one or more embodiments described herein. As shown, Cross-chain Asset Bridging System (“CABS”) 101 may be communicatively coupled to multiple blockchains 103, such as blockchain 103-1 and blockchain 103-2. In some embodiments, blockchain 103-2 may be a “side chain” or “fork” of blockchain 103-1 (e.g., blockchains 103-1 and 103-2 may maintain the same set of blocks, records, etc. up until a particular block, and may maintain different sets of blocks, records, etc. after the particular block). In some embodiments, blockchain 103-2 may be a completely independent blockchain with respect to blockchain 103-1. As such, CABS 101 may be associated with a first set of “wallets,” addresses, nodes, etc. that interact with blockchain 103-1, and may be associated with a second set of “wallets,” addresses, nodes, etc. that interact with blockchain 103-2.

In some embodiments, CABS 101 may be, may implement, may be implemented by, and/or may communicate with one or more decentralized applications (“dApps”) executing on blockchains 103-1 and/or blockchain 103-2. In some embodiments, CABS 101 may implement “oracle” functionality with respect to blockchains 103-1 and blockchain 103-2 (e.g., may communicate with dApps, wallets, addresses, smart contracts, etc. associated with blockchains 103-1 and blockchain 103-2). In some embodiments, CABS 101 may be or may include one or more “off-chain” devices, systems, applications, repositories, etc. For example, CABS 101 may be implemented by one or more devices or systems that are independent from blockchains 103-1 and 103-2.

Each blockchain 103 may be associated with one or more asset exchanges 105, which may sometimes be referred to as marketplaces, NFT marketplaces, or the like. Asset exchanges 105 may provide for the escrow, presentation, transfer, swap, etc. of assets, such as non-fungible assets, that are present on an associated blockchain 103. For example, asset exchange 105-1 may be used to exchange tokens or other assets for particular non-fungible assets that are present on blockchain 103-1 and are made available through asset exchange 105-1 (e.g., by an owner of such non-fungible assets). Similarly, asset exchange 105-2 may be used to exchange tokens or other assets for particular non-fungible assets that are present on blockchain 103-2 and are made available through asset exchange 105-2. For example, when an owner of a given non-fungible asset makes the asset available through asset exchange 105, the non-fungible asset may be staked, deposited, transferred, etc. to an address (e.g., a wallet, a smart contract, etc.) that is associated with asset exchange 105 and is native to the particular blockchain 103 with which asset exchange 105 and the non-fungible asset are associated. Asset exchange 105 may, in turn, maintain (e.g., on blockchain 103 or in some other suitable manner) information associating the staked, deposited, etc. non-fungible asset with the owner that provided the asset, thus maintaining chain of custody of the asset.

In accordance with embodiments described in more detail below, CABS 101 may bridge, transfer, etc. a particular non-fungible asset 107 to one or more recipients associated with blockchain 103-2. Asset 107 may be associated with one or more unique attributes 109. The unique attributes 109 of asset 107 may include provenance information (e.g., a creation or minting date of asset 107, a transaction hash or identifier associated with the creation or minting of asset 107, a chain or history of ownership of asset 107 (e.g., addresses or other identifiers of one or more present or previous owners of asset 107), an identifier of a current owner of asset 107, etc.). Attributes 109 may further include one or more policies, such as restrictions on owners of asset 107 (e.g., where particular addresses, exchanges 105, wallets, smart contracts, etc. may be indicated as prohibited from owning asset 107), restrictions on blockchains to which asset 107 may be transferred (e.g., particular blockchains may be whitelisted or blacklisted, blockchains that do not meet certain environmental or “green” criteria may be prohibited, etc.), or other types of ownership or transfer restrictions. In some embodiments, attributes 109 may include proceeds splitting policies, which may indicate particular addresses, wallets, users, etc. to receive particular portions of proceeds when asset 107 is transferred or sold. In some embodiments, attributes 109 may include one or more other types of policies.

In some embodiments, CABS 101 may verify that policies are received from a creator of asset 107 (e.g., by verifying one or more digital signatures and/or using some other suitable authentication mechanism) before recording such policies with respect to asset 107. In some embodiments, CABS 101 may verify that the creator is also a current owner of asset 107 before recording such policies. For example, in situations where the policies are received from a creator who is not a current owner of asset 107, CABS 101 may refrain from associating such policies with asset 107. In some embodiments, some or all of the policies may be specified on blockchain 103 (e.g., as part of one or more records associated with asset 107 on blockchain 103), and may not be modifiable by any entity once associated with asset 107. In this manner, a creator of asset 107 may be able to have control over the policies associated with asset 107. Further, in some embodiments, such creator may not have the ability to modify such policies once asset 107 is transferred to another owner, thus protecting the integrity of asset 107.

As shown, CABS 101 may receive (at 102) an instruction to bridge asset 107 from blockchain 103-1 to blockchain 103-2. Specifically, for example, asset exchange 105-2 may be specified in the instruction as a target, recipient, etc. of bridged asset 107. The instruction may be received from an owner of asset 107, which may include a wallet that is referred to by an address or other suitable identifier in provenance information associated with asset 107. CABS 101, blockchain 103-1, and/or some other device or system may authenticate the request based on a cryptographic signature or other suitable authentication mechanism (e.g., an owner of asset 107 and/or an associated wallet may have “signed” the instruction).

In some embodiments, the instruction may be received from a client application executing at a User Equipment (“UE”), such as a mobile phone, a laptop computer, etc. In some embodiments, the client application may communicate with CABS 101 via an API, a portal, and/or some other suitable communication pathway. CABS 101 may implement one or more suitable authentication mechanisms to authenticate instructions, requests, etc. from the client. Such authentication mechanisms may include a username and/or password, a biometric authentication mechanism, a cryptographic key-based authentication mechanism, etc. Additionally, or alternatively, in some embodiments, CABS 101 and/or the client may interact with blockchain 103-1 to verify that the client is associated with an owner of asset 107, prior to performing further operations based on the instruction (received at 102) to bridge asset 107 to blockchain 103-2. For example, CABS 101 may verify that blockchain 103-1 stores one or more records indicating that a particular address is an owner of asset 107, and the client (e.g., a wallet or other suitable mechanism associated with the client) may provide a cryptographic signature to CABS 101 to verify that the client is also associated with the owner of asset 107.

CABS 101 may identify (at 104) attributes 109 associated with asset 107. For example, as described below, CABS 101 may identify or maintain information specifying the unique attributes 109 associated with asset 107. Attributes 109 may, for example, include policies relating to ownership or transfer of asset 107. In such situations, CABS 101 may verify whether a target specified in the request (e.g., one or more wallets associated with asset exchange 105-2) are authorized and/or are prohibited by such policies. For example, CABS 101 may determine whether the policies indicate that blockchain 103-2 is an authorized or prohibited blockchain for transfer of asset 107, may determine whether asset exchange 105-2 is indicated as an authorized or prohibited owner of asset 107, etc. In situations where the policies prohibit the transfer (requested at 102), CABS 101 may respond with an error, a failed transaction, etc., in lieu of completing the transfer. For example, CABS 101 may provide such error without transacting with blockchain 103-1 (e.g., based on off-chain operations), in situations where attributes 109 indicate that blockchain 103-2 and/or asset exchange 105-2 are prohibited destinations for bridging asset 107. In this example, assume that the policies do not prohibit asset exchange 105-2, on blockchain 103-2, from owning or receiving asset 107.

Based on the instruction and, in some embodiments, based on determining that the requested transfer is not prohibited or restricted based on policies, CABS 101 may lock (at 104) asset 107 on blockchain 103-1. In some embodiments, locking asset 107 may include staking, depositing, transferring, freezing, etc. asset 107 to an address associated with CABS 101, such as a “burn” smart contract or wallet, or the like. For example, locking asset 107 may include transferring ownership of asset 107 from a previous owner of asset 107 (e.g., from which the instruction was received) to a wallet associated with or selected by CABS 101. In some embodiments, CABS 101 may maintain a record of such staking, depositing, etc., and/or may provide such record to the previous owner of asset 107. When asset 107 is locked, frozen, staked, etc. (at 108) an owner of asset 107 (e.g., an entity that requested the transfer) may be unable to perform other actions with respect to asset 107, such as modifying asset 107, effecting another transfer of asset 107, etc., on blockchain 103-1.

CABS 101 may further mint (at 110) asset 107 on blockchain 103-2, including some or all of the identified attributes 109. Minting asset 107 on blockchain 103-2 may include deploying, executing, interacting with, etc. a smart contract associated with blockchain 103-2. In some embodiments, minting asset 107 on blockchain 103-2 may include generating a token or other type of asset or record that is native to blockchain 103-2, where such token includes and/or includes a reference to some or all of the information, attributes, provenance information, etc. associated with the original asset 107 as generated or provided on blockchain 103-1. In some embodiments, asset 107, as minted on blockchain 103-2, may be, may include, and/or may be referred to as a “wrapped” version of asset 107 as originally provided on blockchain 103-1.

For example, after minting asset 107 on blockchain 103-2, one or more records (e.g., stored in one or more blocks) of blockchain 103-2 may include provenance information of asset 107 as minted on blockchain 103-2, such as a date or time that asset 107 was minted on blockchain 103-2, a transaction identifier associated with a transaction in which asset 107 was minted on blockchain 103-2, an indicator of CABS 101 (e.g., one or more addresses or wallets associated with CABS 101) as a creator or minter of asset 107, or the like. In some embodiments, asset 107 minted on blockchain 103-2 may include provenance information and/or verification information that may be used to verify that asset 107 on blockchain 103-2 is, or refers to, the same asset 107 on blockchain 103-1. For example, asset 107 minted on blockchain 103-2 may include a hash or other value generated based on original asset 107 on blockchain 103-1, such as an object identifier of asset 107 on blockchain 103-1, a hash of data referenced by asset 107 on blockchain 103-1, etc.

In some embodiments, asset 107, when minted on blockchain 103-2, may include or may be associated with information indicating the locking (at 106) of asset 107 on blockchain 103-1. For example, asset 107 on blockchain 103-2 may include information associated with a contract address associated with the locking of asset 107 on blockchain 103-1, a chain identifier associated with blockchain 103-1, a transaction hash or other identifier of a transaction in which asset 107 was locked on blockchain 103-1, etc. In some embodiments, asset 107 on blockchain 103-2 may include Merkle proof information, block header data information, etc. associated with asset 107 on blockchain 103-1, where such information may verify that asset 107 was locked on blockchain 103-1. In this manner, asset 107 on blockchain 103-2 may include a verifiable chain of custody of asset 107, as well as verifiable information that asset 107 on blockchain 103-2 is not simply a copy or duplicate of an asset on blockchain 103-1 that remains available for exchange. That is, the scarcity, rarity, and/or uniqueness of asset 107 may be maintained when asset 107 is bridged to blockchain 103-2. As such, in embodiments where asset 107 on blockchain 103-2 is a “wrapped” or “tokenized” version of asset 107 as provided on blockchain 103-1, the provenance on asset 107 on blockchain 103-2 may be traceable and verifiable to the extent that asset 107 may have been considered to have been completely “moved” or “bridged” to blockchain 103-2 from blockchain 103-1.

Attributes 109, associated with asset 107 on blockchain 103-2, may include one or more attributes of asset 107 discussed above. For example, attributes 109 may include provenance information associated with the creation and/or existence of asset 107 on blockchain 103-1, policies associated with asset 107, and/or other suitable attributes of asset 107. For example, attributes 109 may include an address (e.g., an address associated with blockchain 103-1) of an owner of asset 107 on blockchain 103-1. As such, asset 107 may retain some or all of attributes 109 when bridged from blockchain 103-1 to blockchain 103-2 (e.g., when minted (at 110) on blockchain 103-2).

In some embodiments, CABS 101 may format attributes 109 in a manner that is readable or accessible by asset exchange 105-2. For example, as discussed below, different exchanges 105 may be associated with different types or formats of information, such as different names of data fields, metadata formats, etc. In some embodiments, some exchanges 105 may support certain types of policies, while other exchanges may not. For example, a first exchange 105 may support a fee-splitting policy, while a second exchange 105 may not support a fee-splitting policy.

Once asset 107 has been minted (at 110) on blockchain 103-2, asset 107 may be made available (at 112) for exchange via asset exchange 105-2, associated with blockchain 103-2. For example, CABS 101 may provide, send, transfer, stake, etc. asset 107 to asset exchange 105-2 (e.g., an address associated with asset exchange 105-2), which may include or implement one or more front-end applications, portals, interfaces, etc. via which asset 107 may be made available for viewing, trading, etc. Since asset 107 was minted on blockchain 103-2 with chain of custody and/or provenance information based on which asset 107 can be traced back to creation on blockchain 103-1 (as well as the freezing, locking, etc. of asset 107 on blockchain 103-1), the provenance and uniqueness of asset 107 on blockchain 103-2 (e.g., as presented via asset exchange 105-2) may be able to be readily verified.

In some embodiments, asset exchange 105-2 may access policies associated with asset 107 when presenting information associated with asset 107 (e.g., a listing page offering asset 107 for trade) and/or when facilitating transfers, trades, and/or other transactions associated with asset 107. For example, such policies may specify one or more addresses to which a portion of proceeds of a sale or trade are to be provided when asset 107 is traded or sold via asset exchange 105-2. In such scenarios, asset exchange 105-2 may send proceeds of such sale or trade to the specified address(es), and/or may make such proceeds available for claiming by such specified address(es). Further, asset exchange 105-2 may send (or make available for claiming) some or all proceeds of a sale or trade to an owner of asset 107 specified in provenance information associated with asset 107, which may be the owner of asset 107 on blockchain 103-1. As such, in accordance with embodiments described herein, an asset (such as an NFT) minted on one blockchain 103 may be bridged to another blockchain 103 in a manner that maintains the attributes, provenance, and uniqueness of the original asset, thereby granting the user experience of true cross-chain asset transfer.

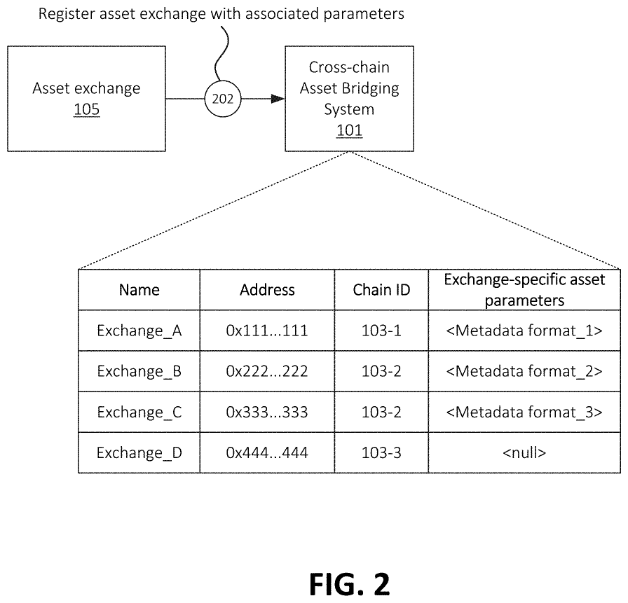

FIG. 2 illustrates an example of the registration of one or more asset exchanges 105 with CABS 101. For example, a given asset exchange 105, associated with a given blockchain 103, may register (at 202) with CABS 101 via an API, a portal, and/or some other suitable communication pathway. For example, a user associated with asset exchange 105 may utilize a cryptographic signature to send a verified registration request (e.g., using a wallet associated with asset exchange 105 or other suitable mechanism) to CABS 101. The request may include one or more addresses associated with asset exchange 105, such as an address to which assets 107 may be transferred, staked, etc. when offered for display or trade via asset exchange 105. The request may include an identifier of a particular blockchain 103 with which asset exchange 105 is associated. Asset exchange 105 may also indicate parameters for assets 107 to be provided (e.g., for presentation or sale) via asset exchange 105. Such parameters may include, for example, formatting of metadata associated with assets 107. Such formatting may allow for the access of information associated with assets 107, such as policies and/or provenance information, by asset exchange 105. For example, asset exchange 105 may access fields having particular names and/or lengths, and/or provided in a particular sequence, in order to identify attributes of particular assets 107. In some embodiments, asset exchange 105 may indicate one or more policies that are supported by and/or are not supported by asset exchange 105. In some embodiments, asset exchange 105 may refrain from providing exchange-specific asset parameters (shown in FIG. 2 as “<null>”), based on which CABS 101 may utilize a “default” formatting of attribute information when providing a given asset 107 to asset exchange 105 for presentation and/or trade.

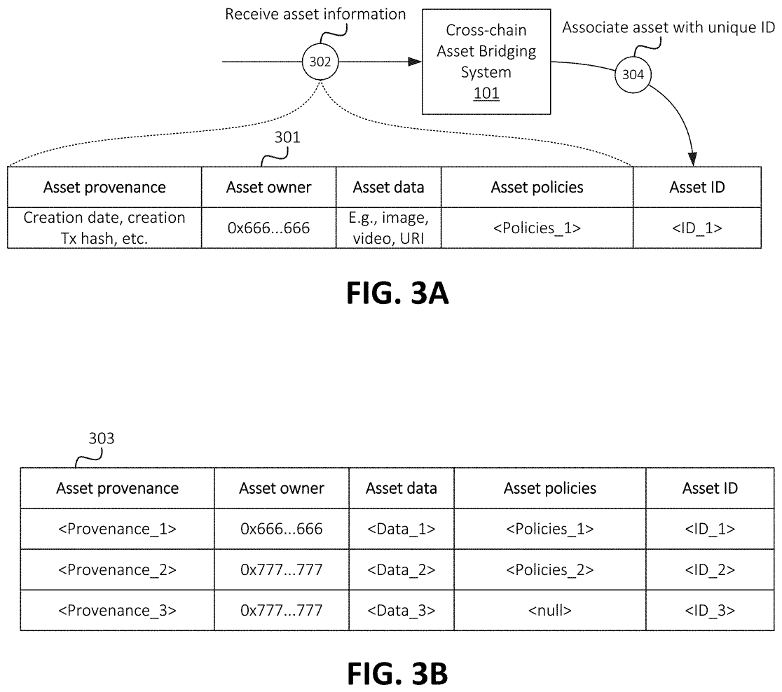

FIGS. 3A and 3B illustrate an example of CABS 101 registering, onboarding, etc. one or more assets 107, which may be bridged in a manner similarly described above once registered, onboarded, etc. As shown in FIG. 3A, CABS 101 may receive (at 302) information 301 regarding a particular asset 107. In some embodiments, CABS 101 may receive information 301 from a client associated with an owner of a particular asset 107. In some embodiments, CABS 101 may authenticate the instruction by requesting that the client sign a message using a private key associated with the client, to verify that the instruction was received from the owner of asset 107. In some embodiments, CABS 101 may “pull” some or all of information 301 from a respective blockchain 103 on which asset 107 is deployed and/or from some other source.

In some embodiments, CABS 101 may receive (at 302) or identify information identifying one or more transactions via which asset 107 was created (e.g., minted) or transferred from one owner to another. For example, CABS 101 may receive (at 302) such transaction information and may automatically identify some or all of the other information 301 associated with asset 107. Additionally, or alternatively, CABS 101 may receive (at 302) some or all of information 301 via one or more messages or other communications provided via an API or other suitable communication pathway associated with CABS 101.

Information 301 may include, for example, provenance information associated with asset 107. As discussed above, such provenance information may include a date and/or time of creation of asset 107, an identifier of one or more transactions by which asset 107 was created, an identifier of one or more transactions by which asset 107 was transferred to a different owner, etc. In some embodiments, such provenance information may include a contract address, asset identifier, etc. on a particular blockchain 103 on which asset 107 was created.

Information 301 may also include an indication of a current owner of asset 107, where such owner is specified as an address associated with blockchain 103-1. For example, the abbreviation “0x666 . . . 666” may refer to such address (referred to herein as an “abbreviated address”), which may include more alphanumeric characters than the abbreviated address. In some embodiments, the information indicating the owner may be a subset of the provenance information, and/or may otherwise identified from the provenance information. For example, on-chain data may identify the owner of asset 107. In some embodiments, the provenance information may include one or more addresses associated with one or more different blockchains 103 that are associated with an owner of asset 107 on the source blockchain 103 (e.g., the particular blockchain 103 on which asset 107 was created and/or is currently held). For example, when asset 107 is transferred to such different blockchains 103, the specified address(es) may be authorized to perform actions with respect to transferred asset 107, such as offering transferred asset 107 for trade, claiming ownership of asset 107, etc.

Information 301 may also include asset data, such as image, videos, links (e.g., Uniform Resource Identifiers (“URIs”), Uniform Resource Locators (“URLs”), reference to a drive or directory in a storage system, etc.), and/or other suitable type of data being represented, authenticated, etc. by asset 107. In some embodiments, some or all asset data may be “off-chain” data that is not stored on a blockchain, and/or that is stored on a blockchain that is different from the blockchain on which asset 107 was created or is currently held. For example, on-chain data associated with asset 107 may include a URI to a web-accessible video resource, while the video resource itself may be of a relatively large size that may not be feasible to store on-chain. CABS 101 may also receive (at 302) policy information associated with asset 107. As noted above, such policy information may include restrictions on transfer or ownership, proceeds splitting policies, and/or other suitable policies.

CABS 101 may associate (at 304) asset 107 with a unique asset identifier (e.g., (“<ID_1>” in this example), where different assets 107 are associated with different identifiers. In some embodiments, CABS 101 may generate the unique asset identifier based on the provenance information associated with asset 107, and/or may extract the unique asset identifier from the provenance information. In some embodiments, the unique asset identifier may be generated or determined independently from the provenance information.

As shown in FIG. 3B, data structure 303 may include information associated with multiple assets 107, having the identifiers <ID_1>, <ID_2>, and <ID_3>. As similarly discussed above, each respective asset 107 may be associated with a respective set of provenance information, an owner, asset data, and policies. In some situations, the same owner may be associated with multiple assets 107 (e.g., the assets having identifiers <ID_2> and <ID_3> are associated with the same owner associated with the abbreviated address “0x777 . . . 777” in this example). Further, in some scenarios, an asset 107 may not be associated with any policies (denoted by “<null>” in this example). For example, such asset 107 may not have restrictions on transfer or trade, fee splitting policies, etc.

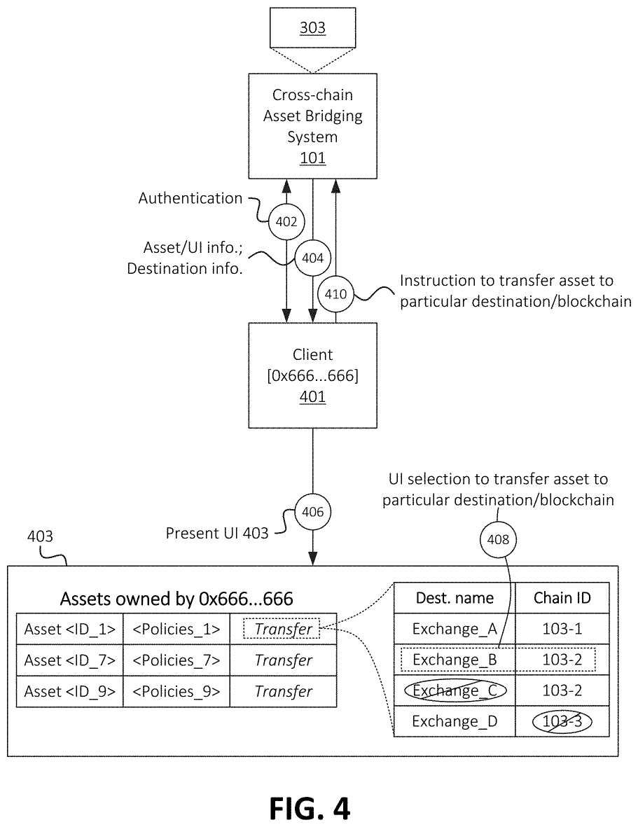

FIG. 4 illustrates example interactions between a particular client 401 and CABS 101 in order to transfer a particular asset 107 from a first blockchain 103 to a different blockchain 103. Client 401 may be associated with an address that is different from a creator of one or more assets 107 discussed herein. For example, client 401 may be associated with an address that has traded for or has otherwise received ownership of one or more assets 107. In some embodiments, client 401 may be associated with a particular address of a particular blockchain 103. In this example, assume that client 401 is associated with a particular address associated with blockchain 103-1, such as the abbreviated address 0x666 . . . 666. CABS 101 may authenticate (at 402) client 401, which may include receiving a cryptographically signed message from client 401 in accordance with one or more protocols associated with the same blockchain 103 with which the address of client 401 is associated.

As noted above, CABS 101 may maintain data structure 303, which may store information associated with one or more assets 107 with which client 401 is associated (e.g., where an address associated with client 401 is an owner of such assets 107). Based on authenticating or otherwise identifying the address of client 401, CABS 101 may provide (at 404) information regarding assets 107 with which client 401 (e.g., an address of client 401) is associated as an owner. In this example, such assets 107 may include assets 107 with the example identifiers <ID_1>, <ID_7>, and <ID_9>. CABS 101 may also identify policies associated with such assets 107, which may include proceeds splitting policies, restrictions on transfer or ownership, etc. CABS 101 may further provide (at 404) a user interface (“UI”), such as example UI 403, to client 401. Client 401 may present (at 406) UI 403 via, for example, a display device associated with client 401 (e.g., a display device communicatively coupled to or integrated in a UE executing client 401).

As shown, UI 403 may indicate the particular assets 107 with which client 401 is associated. In some embodiments, the identifiers of assets 107 may be presented via UI 403. In some embodiments, thumbnails, images, etc. associated with each asset 107 may be presented via UI 403 (e.g., where such thumbnails, images, and/or links thereto are stored by CABS 101 in data structure 303). UI 403 may also indicate particular policies associated with each asset 107, such as an indication of restricted owners, blockchains, exchanges, etc. UI 403 may also include one or more selectable options to transfer, bridge, etc. one or more of the assets 107 to a target destination, such as a different blockchain 103 (e.g., an asset exchange 105 or other address on the other blockchain 103).

In this example, assume that a user of client 401 selects an option to transfer the asset 107 associated with the identifier <ID_1>. Based on the selection, UI 403 may present a list of exchanges that have registered with CABS 101 (e.g., as described above with respect to FIG. 2). In some embodiments, UI 403 may include an indication of target destinations that are restricted based on policies associated with a given asset 107. For example, assume that the set of policies (e.g., <Policies 1>) associated with the selected asset 107 indicate that Exchange_C and blockchain 103-3 are restricted destinations for asset 107. UI 403 may include an indication (shown here as a circle with a slash) indicating that asset 107 may not be transferred to Exchange_C, as well as an indication that asset 107 may not be transferred to blockchain 103-3 (including to Exchange_D, which is on blockchain 103-3). In some embodiments, UI 403 may indicate such restrictions in some other manner, such as by omitting restricted destinations from the list of destinations when asset 107 is selected to be bridged.

In this example, assume that Exchange_B, on blockchain 103-2, is selected (at 408) as a target for the transfer of asset 107. Client 401 may, based on the selection, output (at 410) an instruction, to CABS 101, to transfer the particular asset 107 to Exchange_B on blockchain 103-2.

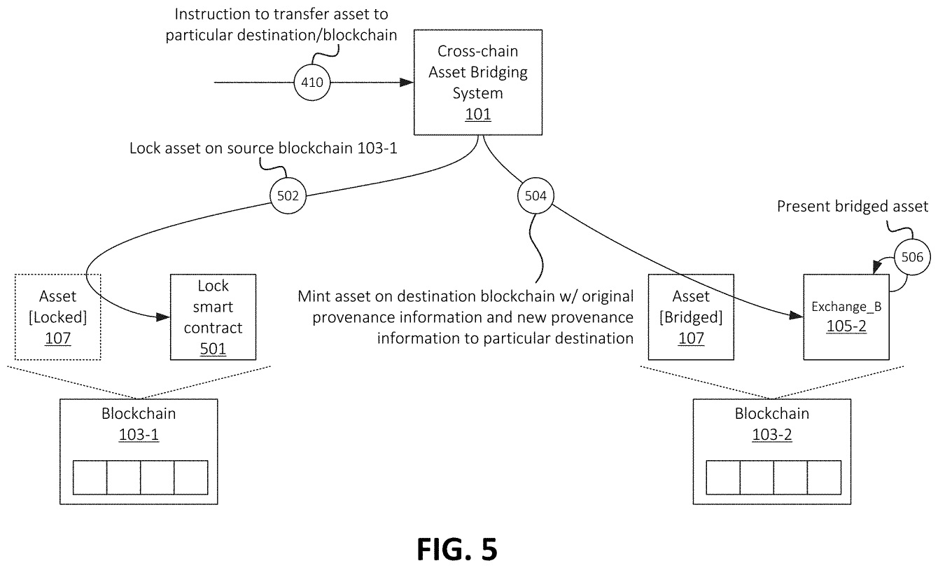

FIG. 5 illustrates an example of transferring the particular asset 107, selected for transfer in the example of FIG. 4, from blockchain 103-1 to blockchain 103-2. For example, based on the instruction (at 410) to transfer asset 107 from blockchain 103-1 to asset exchange 105-2 on blockchain 103-2, CABS 101 may lock (at 502) asset 107 on blockchain 103-1. For example, CABS 101 may assign a “lock” address, smart contract, etc., such as lock smart contract 501, as an owner of asset 107 on blockchain 103-1. In some embodiments, CABS 101 may generate a token or receipt indicating that the owner of asset 107 (e.g., associated with client 401 requesting the transfer) was the owner of asset 107 prior to locking asset 107. In this sense, in the event that asset 107 is returned to blockchain 103-1 without ultimately transferring ownership of asset 107, the original owner of asset 107 may utilize the token or receipt to redeem or otherwise recover asset 107.

CABS 101 may further create, mint, etc. (at 504) asset 107 on blockchain 103-2. For example, CABS 101 may specify asset exchange 105-2 (e.g., an address associated with asset exchange 105-2) as an owner of minted asset 107 on blockchain 103-2. As noted above, minted asset 107 on blockchain 103-2 may include some or all of the asset information associated with asset 107, such as some or all of the information stored in data structure 303 with respect to asset 107. Additionally, or alternatively, minted asset 107 may be associated with the same identifier (e.g., <ID_1>, <ID_2>, etc.) as the original asset 107, based on which one or more records in data structure 303 may be identified.

For example, minted asset 107 may include or may otherwise be associated with some or all of the original provenance information of asset 107 as created on blockchain 103-1, such as an original creation date, an address of a creator of asset 107 on blockchain 103-1, an owner of asset 107 on blockchain 103-1 from which the instruction to transfer asset 107 was received, etc. For example, one or more records on blockchain 103-2, associated with the minting of asset 107 on blockchain 103-2, may include some or all of such information. Additionally, or alternatively, such record(s) may include an identifier of asset 107 (e.g., <ID_1>, <ID_2>, etc.), a link to CABS 101 and/or to data structure 303, based on which original provenance information of minted asset 107 may be identified. Similarly, minted asset 107 may include or may otherwise be associated with some or all of the policies and/or other attributes 109 of the original asset 107.

In some embodiments, CABS 101 may wait for a confirmation of the locking (at 502) of asset 107 on blockchain 103-1 before minting (at 504) asset 107 on blockchain 103-2. For example, CABS 101 may wait for a transaction confirmation from blockchain 103-1 of the transfer of asset 107 to lock smart contract 501 prior to minting asset 107 on blockchain 103-2. In this manner, CABS 101 may avoid duplicating asset 107 on multiple blockchains 103. In some embodiments, CABS 101 may perform the locking (at 502) and minting (at 504) simultaneously and/or atomically, in that the locking and minting may both be performed in an interdependent manner. For example, the locking on blockchain 103-1 may be performed based on confirmation that asset 107 is able to be created on blockchain 103-2, and the creation on blockchain 103-2 may be performed based on confirmation that asset 107 is able to be locked on blockchain 103-1. In such situations, the failure of one action (e.g., the failure to lock asset 107 on blockchain 103-1 or the failure to mint asset 107 on blockchain 103-2) may cause the other action to fail or to be reversed.

Asset exchange 105-2 may present (at 506) the bridged asset 107 via UI, web portal, interface, etc. For example, asset exchange 105-2 may include and/or may be implemented by a dApp executing on blockchain 103-2 and/or some other type of application, device, or system. In some embodiments, asset exchange 105-2 may receive (at 602) asset transfer parameters associated with bridged asset 107 from client 601. In some embodiments, client 601 may be associated with client 401 from which the instruction to transfer asset 107 from blockchain 103-1 to blockchain 103-2 was received. In some embodiments, client 601 and client 401 may be associated with the same address (e.g., in situations where blockchains 103-1 and blockchain 103-2 utilize the same addresses). For example, as discussed above, the provenance information for asset 107 may specify the same address as an owner on blockchains 103-1 and blockchain 103-2. Additionally, or alternatively, clients 401 and 601 may be associated with different addresses, and the provenance information associated with asset 107 may include a mapping between such different addresses. As such, asset exchange 105-2 may authenticate the parameters received (at 602) from client 601 prior to associating a given asset 107 with such parameters and/or prior to offering such asset 107 for trade. The asset transfer parameters may include a price and/or indication of particular types and/or amounts of assets for which asset 107 may be traded.

UI 603 may be presented to client 601 and/or to other entities (e.g., addresses associated with blockchain 103-2, with which asset exchange 105-2 is associated). For example, UI 603 may be associated with a marketplace or other type of mechanism by which assets 107 may be traded for, displayed, etc. For example, with respect to asset 107 having the identifier <ID_3>, UI 603 may display asset data associated with asset 107, such as image 605 (e.g., which may be off-chain data retrieved using a link associated with asset 107, and/or which may be included in on-chain data associated with asset 107). UI 603 may further include an indication 607 of policy information, such as an indication of one or more addresses that will receive portions of proceeds if asset 107 is transferred, swapped, traded for, purchased, etc. Additionally, or alternatively, in some embodiments, UI 603 may not present such information. UI 603 may further present information 609, indicating some or all of the asset transfer parameters for asset 107. For example, information 609 may indicate that asset 107 may be exchanged for 1.23 “XYZ” Tokens, which may be a particular token that is deployed on blockchain 103-2. In some embodiments, information 609 may indicate a minimum or reserve price for asset 107, in embodiments where asset exchange 105-2 provides for an auction of asset 107.

UI 603 may also present a selectable option to trade for asset 107 (e.g., for an amount of assets, tokens, etc. specified by the asset transfer parameters). For example, another client associated with blockchain 103-2 may access UI 603, may select the “trade” selectable option, and may provide the appropriate assets in exchange for asset 107 to asset exchange 105-2. Asset exchange 105-2 may provide some or all of the proceeds to the owner of asset 107 as specified in the provenance information associated with asset 107. Asset exchange 105-2 may further provide an appropriate amount of assets to one or more other entities, such as addresses specified in the policies for asset 107 as addresses to which proceeds should be split. In some embodiments, asset exchange 105-2 may hold some or all of the proceeds when asset 107 is traded for, and the previous owner of asset 107 (e.g., the previous owner who listed asset 107 as available for trade) and/or the other entities may be provided with an option to claim such proceeds from asset exchange 105-2.

In some embodiments, when asset 107 is traded via asset exchange 105-2, asset exchange 105-2 may provide information indicating a new owner of asset 107 to CABS 101. CABS 101 may update off-chain information and/or an oracle service based on the new owner of asset 107. For example, CABS 101 may update data structure 303 to indicate that the owner of asset 107 is the new owner on blockchain 103-2.

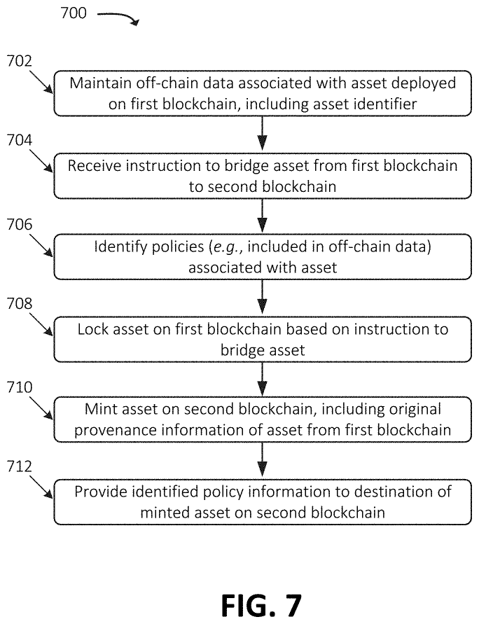

FIG. 7 illustrates an example process 700 for performing a cross-chain asset transfer (e.g., bridging), retaining unique attributes of the transferred asset. In some embodiments, some or all of process 700 may be performed by CABS 101. In some embodiments, one or more other devices may perform some or all of process 700 in concert with, and/or in lieu of, CABS 101.

As shown, process 700 may include maintaining (at 702) off-chain data associated with an asset deployed on a first blockchain. The off-chain data may include a unique identifier of the asset. For example, as discussed above, CABS 101 may include and/or may be communicatively coupled to one or more repositories that store information (e.g., data structure 303 and/or some other suitable data structure) associated with one or more assets 107. Such data may be “off-chain” inasmuch as the data is stored separate from blockchain 103 on which asset 107 is deployed. In some embodiments, the off-chain data may be stored on a different blockchain, such as a private blockchain (e.g., a blockchain to which only CABS 101 and/or other authorized entities have access). In some embodiments, the off-chain data may be stored in a database or some other form of data storage that does not include a blockchain. The off-chain data may include provenance information associated with asset 107, such as a date and/or time of creation, an identifier (e.g., an address on blockchain 103) of a creator of asset 107, an identifier of a current owner of asset 107, etc. In some embodiments, the provenance information may include a copy of, may include a link or reference to, and/or may otherwise be derived from, provenance information associated with asset 107 that is stored on blockchain 103.

Process 700 may further include receiving (at 704) an instruction to bridge the asset from the first blockchain to a second blockchain. For example, CABS 101 may receive an instruction from an owner of asset 107 (e.g., as specified in the provenance information). For example, CABS 101 may receive such instruction from client 401 associated with the same address specified in the provenance information for asset 107. CABS 101 may authenticate the instruction by requesting that client 401 sign a message using a private key associated with client 401 and/or the address of the owner of asset 107. As discussed above, CABS 101 may receive such instruction via a selection of a UI element, which may also include a selection of a target or destination for asset 107. The target or destination for asset 107 may include an address on a second blockchain 103. In some embodiments, the target or destination for asset 107 may be the same address as the present owner on the second blockchain 103, may be an address of an asset exchange 105 on the second blockchain 103, and/or may be some other address on the second blockchain 103. In some embodiments, the instruction may not specify a particular address for the transfer, in which case CABS 101 may utilize a “default” or “holding” address, and/or may utilize the same address as the owner of asset 107 (e.g., where the first and second blockchains 103 utilize the same address space and/or naming conventions).

Process 700 may additionally include identifying (at 706) policies associated with the asset. As discussed above, such policies may be included in the off-chain data associated with asset 107. The policies may include restrictions on ownership or transfer, proceeds splitting policies, or the like. As discussed above, CABS 101 may reject the requested transfer in situations where the rejected transfer would violate one or more policies (e.g., an attempt to transfer asset 107 to a restricted address and/or blockchain). Such rejection may be made without interacting with blockchain 103, as the rejection may be made by CABS 101 based on policies (e.g., stored in off-chain data) that indicate that the transfer would violate the policies.

Assuming the request was not rejected (at 706), process 700 may also include locking (at 708) the asset on the first blockchain based on the instruction to bridge the asset to the second blockchain. For example, CABS 101 may transfer ownership of asset 107, on the first blockchain 103, to a lock address associated with CABS 101. CABS 101 may generate a token or receipt indicating that the requestor (e.g., a present owner of asset 107) is associated with locked asset 107, in the event that asset 107 is to be unlocked and provided back to the requestor at some future time (e.g., if asset 107 is bridged back to the first blockchain 103).

Process 700 may further include minting (at 710) the asset on the second blockchain, including the original provenance information of the asset from the first blockchain. For example, the minted asset 107 may include one or more records that are a copy of some or all of the original provenance information of asset 107 (e.g., as stored in the off-chain data). In some embodiments, minted asset 107 may include a link or identifier associated with a record of the first blockchain 103, where such record is associated with the creation of asset 107 on the first blockchain 103. Minted asset 107 may also include one or more records that are a copy of some or all of the policy information associated with asset 107, and/or a link or reference to policy information associated with asset 107. In some embodiments, such link or reference may be, or may include, the unique identifier of asset 107 (e.g., as stored in the off-chain data). Minted asset 107 may also include some or all of the asset information associated with the original asset 107, such as an image, a video, audio data, and/or a link or reference to such data (e.g., a link or reference to information stored by CABS 101 or some other device or system).

Process 700 may additionally include providing (at 712) the identified policy information to the destination of the minted asset on the second blockchain. For example, CABS 101 may communicate with the destination via an API or other suitable communication pathway to provide the policy information associated with minted asset 107. As discussed above, the destination (e.g., a particular asset exchange 105) may have previously registered with CABS 101 in order to receive such communications and implement such policies. Asset exchange 105 may, for example, present minted asset 107 for trade in accordance with the policies. Asset exchange 105 may provide proceeds from such trade to the previous owner (e.g., where the “previous” owner refers to the owner of asset 107 immediately prior to the trade, such as the requestor of the bridging) of minted asset 107, and/or may hold such proceeds for claiming by such previous owner. Additionally, or alternatively, asset exchange 105 may provide the proceeds from such trade to an address associated with CABS 101, and CABS 101 may subsequently distribute the proceeds to the previous owner of asset 107. Further, as discussed above, asset exchange 105 may provide an apportioned amount of proceeds to one or more addresses specified by the policy information, in situations where the policy information indicates a proceeds splitting policy.

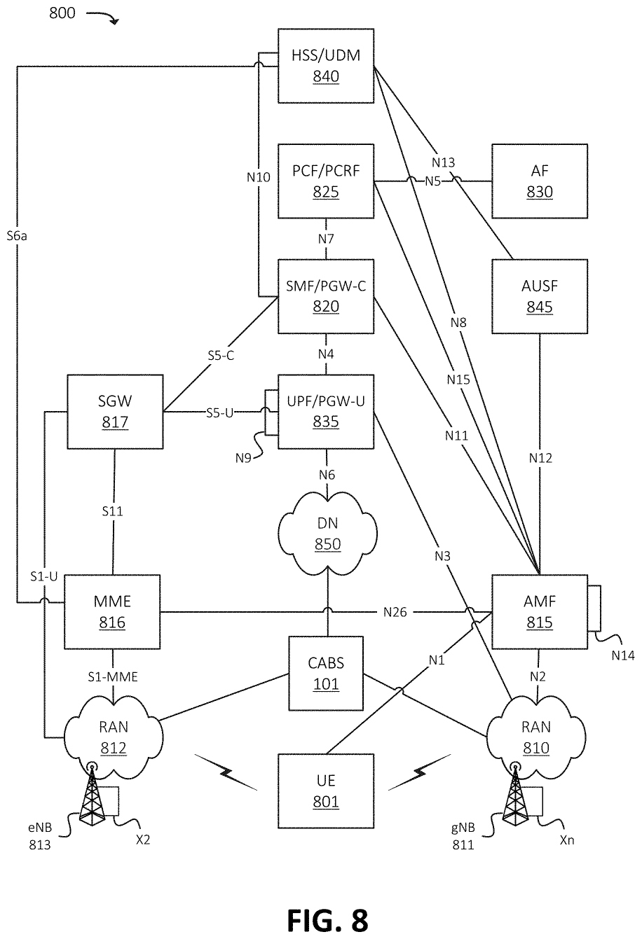

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 800 may include UE 801, RAN 810 (which may include one or more Next Generation Node Bs (“gNBs”) 811), RAN 812 (which may include one or more evolved Node Bs (“eNBs”) 813), and various network functions such as Access and Mobility Management Function (“AMF”) 815, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, Policy Control Function (“PCF”)/Policy Charging and Rules Function (“PCRF”) 825, Application Function (“AF”) 830, User Plane Function (“UPF”)/PGW-User plane function (“PGW-U”) 835, Home Subscriber Server (“HSS”)/Unified Data Management (“UDM”) 840, and Authentication Server Function (“AUSF”) 845. Environment 800 may also include one or more networks, such as Data Network (“DN”) 850. Environment 800 may include one or more additional devices or systems communicatively coupled to one or more networks (e.g., DN 850), such as CABS 101 and/or one or more devices or systems (e.g., nodes, validators, delegators, etc.) implementing one or more blockchains 103.

The example shown in FIG. 8 illustrates one instance of each network component or function (e.g., one instance of SMF/PGW-C 820, PCF/PCRF 825, UPF/PGW-U 835, HSS/UDM 840, and/or AUSF 845). In practice, environment 800 may include multiple instances of such components or functions. For example, in some embodiments, environment 800 may include multiple “slices” of a core network, where each slice includes a discrete set of network functions (e.g., one slice may include a first instance of SMF/PGW-C 820, PCF/PCRF 825, UPF/PGW-U 835, HSS/UDM 840, and/or AUSF 845, while another slice may include a second instance of SMF/PGW-C 820, PCF/PCRF 825, UPF/PGW-U 835, HSS/UDM 840, and/or AUSF 845). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. Alternatively, or additionally, one or more of the devices of environment 800 may perform one or more network functions described as being performed by another one or more of the devices of environment 800. Devices of environment 800 may interconnect with each other and/or other devices via wired connections, wireless connections, or a combination of wired and wireless connections. In some implementations, one or more devices of environment 800 may be physically integrated in, and/or may be physically attached to, one or more other devices of environment 800.

UE 801 may include a computation and communication device, such as a wireless mobile communication device that is capable of communicating with RAN 810, RAN 812, and/or DN 850. UE 801 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), or another type of mobile computation and communication device. UE 801 may send traffic to and/or receive traffic (e.g., user plane traffic) from DN 850 via RAN 810, RAN 812, and/or UPF/PGW-U 835. In some embodiments, client 401 and/or some or all of blockchain 103 may be, may include, or may be implemented by one or more UEs 801 or other types of suitable devices or systems.

RAN 810 may be, or may include, a 5G RAN that includes one or more base stations (e.g., one or more gNBs 811), via which UE 801 may communicate with one or more other elements of environment 800. UE 801 may communicate with RAN 810 via an air interface (e.g., as provided by gNB 811). For instance, RAN 810 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 810 may receive traffic intended for UE 801 (e.g., from UPF/PGW-U 835, AMF 815, and/or one or more other devices or networks) and may communicate the traffic to UE 801 via the air interface.

RAN 812 may be, or may include, a LTE RAN that includes one or more base stations (e.g., one or more eNBs 813), via which UE 801 may communicate with one or more other elements of environment 800. UE 801 may communicate with RAN 812 via an air interface (e.g., as provided by eNB 813). For instance, RAN 810 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 810 may receive traffic intended for UE 801 (e.g., from UPF/PGW-U 835, SGW 817, and/or one or more other devices or networks) and may communicate the traffic to UE 801 via the air interface.

AMF 815 may include one or more devices, systems, Virtualized Network Functions (“VNFs”), Cloud-Native Network Functions (“CNFs”), etc., that perform operations to register UE 801 with the 5G network, to establish bearer channels associated with a session with UE 801, to hand off UE 801 from the 5G network to another network, to hand off UE 801 from the other network to the 5G network, manage mobility of UE 801 between RANs 810 and/or gNBs 811, and/or to perform other operations. In some embodiments, the 5G network may include multiple AMFs 815, which communicate with each other via the N14 interface (denoted in FIG. 8 by the line marked “N14” originating and terminating at AMF 815).

MME 816 may include one or more devices, systems, VNFs, CNFs, etc., that perform operations to register UE 801 with the EPC, to establish bearer channels associated with a session with UE 801, to hand off UE 801 from the EPC to another network, to hand off UE 801 from another network to the EPC, manage mobility of UE 801 between RANs 812 and/or eNBs 813, and/or to perform other operations.

SGW 817 may include one or more devices, systems, VNFs, CNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, CNFs, etc., that gather, process, store, and/or provide information in a manner described herein. SMF/PGW-C 820 may, for example, facilitate the establishment of communication sessions on behalf of UE 801. In some embodiments, the establishment of communications sessions may be performed in accordance with one or more policies provided by PCF/PCRF 825.

PCF/PCRF 825 may include one or more devices, systems, VNFs, CNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, CNFs, etc., that receive, store, and/or provide information that may be used in determining parameters (e.g., quality of service parameters, charging parameters, or the like) for certain applications.

UPF/PGW-U 835 may include one or more devices, systems, VNFs, CNFs, etc., that receive, store, and/or provide data (e.g., user plane data). For example, UPF/PGW-U 835 may receive user plane data (e.g., voice call traffic, data traffic, etc.), destined for UE 801, from DN 850, and may forward the user plane data toward UE 801 (e.g., via RAN 810, SMF/PGW-C 820, and/or one or more other devices). In some embodiments, multiple UPFs 835 may be deployed (e.g., in different geographical locations), and the delivery of content to UE 801 may be coordinated via the N9 interface (e.g., as denoted in FIG. 8 by the line marked “N9” originating and terminating at UPF/PGW-U 835). Similarly, UPF/PGW-U 835 may receive traffic from UE 801 (e.g., via RAN 810, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

HSS/UDM 840 and AUSF 845 may include one or more devices, systems, VNFs, CNFs, etc., that manage, update, and/or store, in one or more memory devices associated with AUSF 845 and/or HSS/UDM 840, profile information associated with a subscriber. AUSF 845 and/or HSS/UDM 840 may perform authentication, authorization, and/or accounting operations associated with the subscriber and/or a communication session with UE 801.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 801 may communicate, through DN 850, with data servers, other UEs 801, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 801 may communicate.

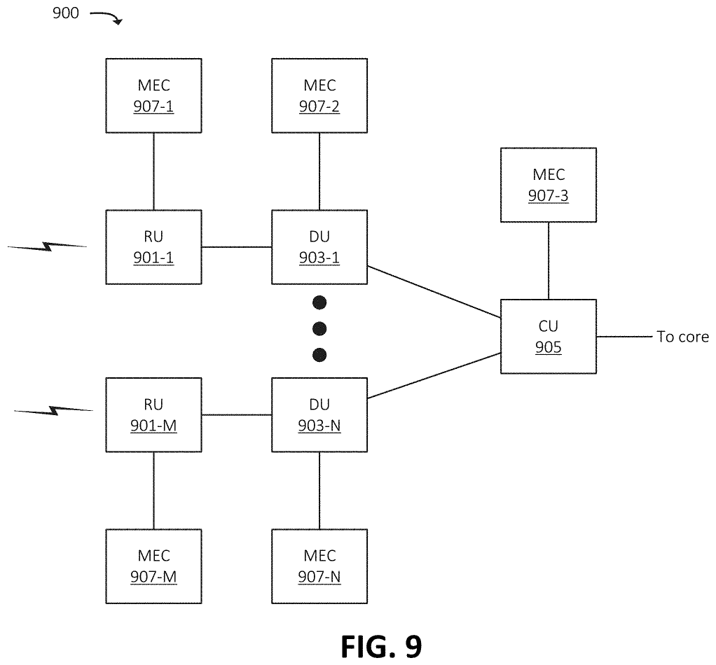

FIG. 9 illustrates an example Distributed Unit (“DU”) network 900, which may be included in and/or implemented by one or more RANs (e.g., RAN 810, RAN 812, or some other RAN). In some embodiments, a particular RAN may include one DU network 900. In some embodiments, a particular RAN may include multiple DU networks 900. In some embodiments, DU network 900 may correspond to a particular gNB 811 of a 5G RAN (e.g., RAN 810). In some embodiments, DU network 900 may correspond to multiple gNBs 811. In some embodiments, DU network 900 may correspond to one or more other types of base stations of one or more other types of RANs. As shown, DU network 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 815 and/or UPF/PGW-U 835). In the uplink direction (e.g., for traffic from UEs 801 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 801, and may determine which DU(s) 903 should receive the downlink traffic. DU 903 may include one or more devices that transmit traffic between a core network (e.g., via CU 905) and UE 801 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 801.

RU 901 may include hardware circuitry (e.g., one or more RF transceivers, antennas, radios, and/or other suitable hardware) to communicate wirelessly (e.g., via an RF interface) with one or more UEs 801, one or more other DUs 903 (e.g., via RUs 901 associated with DUs 903), and/or any other suitable type of device. In the uplink direction, RU 901 may receive traffic from UE 801 and/or another DU 903 via the RF interface and may provide the traffic to DU 903. In the downlink direction, RU 901 may receive traffic from DU 903, and may provide the traffic to UE 801 and/or another DU 903.

RUs 901 may, in some embodiments, be communicatively coupled to one or more Multi-Access/Mobile Edge Computing (“MEC”) devices, referred to sometimes herein simply as “MECs” 907. For example, RU 901-1 may be communicatively coupled to MEC 907-1, RU 901-M may be communicatively coupled to MEC 907-M, DU 903-1 may be communicatively coupled to MEC 907-2, DU 903-N may be communicatively coupled to MEC 907-N, CU 905 may be communicatively coupled to MEC 907-3, and so on. MECs 907 may include hardware resources (e.g., configurable or provisionable hardware resources) that may be configured to provide services and/or otherwise process traffic to and/or from UE 801, via a respective RU 901.

For example, RU 901-1 may route some traffic, from UE 801, to MEC 907-1 instead of to a core network (e.g., via DU 903 and CU 905). MEC 907-1 may process the traffic, perform one or more computations based on the received traffic, and may provide traffic to UE 801 via RU 901-1. In this manner, ultra-low latency services may be provided to UE 801, as traffic does not need to traverse DU 903, CU 905, and an intervening backhaul network between DU network 900 and the core network. In some embodiments, MEC 907 may include, and/or may implement, some or all of the functionality described above with respect to CABS 101 and/or one or more nodes of one or more blockchains 103.

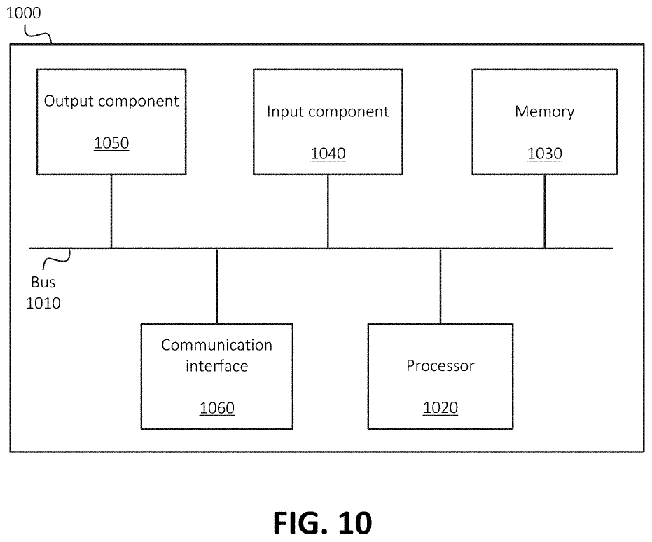

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

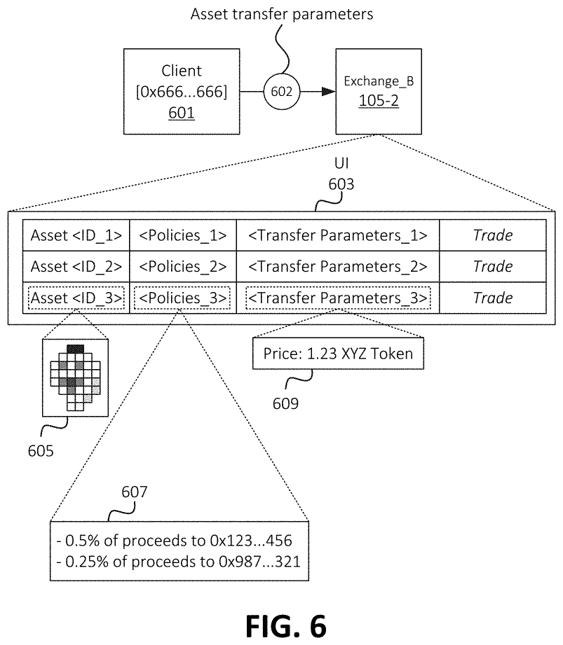

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive provenance information associated with a particular asset that is associated with a first blockchain;
associate the particular asset with a particular identifier;
receive an instruction to bridge the asset to a second blockchain; and
based on receiving the instruction to bridge the asset to the second blockchain:
lock the asset on the first blockchain, and
mint the asset on the second blockchain, wherein the minted asset includes the particular identifier.

2. The device of claim 1, with the one or more processors are further configured to:
maintain a set of asset data associated with the particular asset, wherein the set of asset data is associated with the particular identifier.

3. The device of claim 2, wherein the asset data includes a link to data that is stored separately from the first and second blockchains.

4. The device of claim 1, wherein the provenance information includes information associated with a creation of the particular asset on the first blockchain, wherein minting the asset on the second blockchain includes associating the minted asset on the second blockchain with the information associated with the creation of the particular asset on the first blockchain.

5. The device of claim 4, wherein the information associated with the creation of the particular asset on the first blockchain is further associated with the particular identifier in a data repository that is separate from the first and second blockchains.

6. The device of claim 1, wherein locking the asset on the first blockchain includes transferring the asset, on the first blockchain, to a lock address associated with the first blockchain.

7. The device of claim 6, wherein the one or more processors are further configured to:
receive confirmation that the asset has been transferred to the lock address associated with the first blockchain,
wherein minting the asset on the second blockchain is performed based on receiving the confirmation that the asset has been transferred to the lock address associated with the first blockchain.

8. A non-transitory computer-readable medium, storing a plurality of processor-executable instructions to:
receive provenance information associated with a particular asset that is associated with a first blockchain;
associate the particular asset with a particular identifier;
receive an instruction to bridge the asset to a second blockchain; and
based on receiving the instruction to bridge the asset to the second blockchain:
lock the asset on the first blockchain, and
mint the asset on the second blockchain, wherein the minted asset includes the particular identifier.

9. The non-transitory computer-readable medium of claim 8, wherein the one or more processors are further configured to:
maintain a set of asset data associated with the particular asset, wherein the set of asset data is associated with the particular identifier.

10. The non-transitory computer-readable medium of claim 9, wherein the asset data includes a link to data that is stored separately from the first and second blockchains.

11. The non-transitory computer-readable medium of claim 8, wherein the provenance information includes information associated with a creation of the particular asset on the first blockchain, wherein minting the asset on the second blockchain includes associating the minted asset on the second blockchain with the information associated with the creation of the particular asset on the first blockchain.

12. The non-transitory computer-readable medium of claim 11, wherein the information associated with the creation of the particular asset on the first blockchain is further associated with the particular identifier in a data repository that is separate from the first and second blockchains.

13. The non-transitory computer-readable medium of claim 8, wherein locking the asset on the first blockchain includes transferring the asset, on the first blockchain, to a lock address associated with the first blockchain.

14. The non-transitory computer-readable medium of claim 13, wherein the plurality of processor-executable instructions further include processor-executable instructions to:
receive confirmation that the asset has been transferred to the lock address associated with the first blockchain,
wherein minting the asset on the second blockchain is performed based on receiving the confirmation that the asset has been transferred to the lock address associated with the first blockchain.

15. A method, comprising:
receiving provenance information associated with a particular asset that is associated with a first blockchain;
associating the particular asset with a particular identifier;
receiving an instruction to bridge the asset to a second blockchain; and
based on receiving the instruction to bridge the asset to the second blockchain:
locking the asset on the first blockchain, and
minting the asset on the second blockchain, wherein the minted asset includes the particular identifier.

16. The method of claim 15, further comprising:
maintaining a set of asset data associated with the particular asset, wherein the set of asset data is associated with the particular identifier.

17. The method of claim 16, wherein the asset data includes a link to data that is stored separately from the first and second blockchains.

18. The method of claim 15, wherein the provenance information includes information associated with a creation of the particular asset on the first blockchain, wherein minting the asset on the second blockchain includes associating the minted asset on the second blockchain with the information associated with the creation of the particular asset on the first blockchain.

19. The method of claim 18, wherein the information associated with the creation of the particular asset on the first blockchain is further associated with the particular identifier in a data repository that is separate from the first and second blockchains.

20. The method of claim 15, wherein locking the asset on the first blockchain includes transferring the asset, on the first blockchain, to a lock address associated with the first blockchain, the method further comprising:
receiving confirmation that the asset has been transferred to the lock address associated with the first blockchain,
wherein minting the asset on the second blockchain is performed based on receiving the confirmation that the asset has been transferred to the lock address associated with the first blockchain.
